(19) United States
(12) Patent Application Publication
(10) Pub. No.: US 2015/0324216 A1
(43) Pub. Date: Nov. 12, 2015

(54) SELF-REPAIRING CONFIGURATION SERVICE FOR VIRTUAL MACHINE MIGRATION

(71) Applicant: NETAPP, INC., Sunnyvale, CA (US)

(72) Inventors: Glenn Sizemore, Raleigh, NC (US); Barry Shilmover, Bellevue, WA (US)

(73) Assignee: NETAPP, INC., Sunnyvale, CA (US)

(21) Appl. No.: 14/503,338

(22) Filed: Sep. 30, 2014

Related U.S. Application Data
(63) Continuation-in-part of application No. 14/296,695, filed on Jun. 5, 2014.
(60) Provisional application No. 61/992,108, filed on May 12, 2014.

(51) Int. Cl. G06F 9/455

(52) U.S. Cl. CPC G06F 9/45558; G06F 9/45545; G06F 2009/4557

(57) ABSTRACT

Techniques for self-repairing configuration service are described. An apparatus may comprise a self-repairing configuration service component to execute a self-repairing configuration service for a guest operating system executing on a virtual machine. The self-repairing configuration service to detect a guest operating system executing on the virtual machine, detect a change to a host hypervisor of the virtual machine, and reconfigure one or more network interfaces and one or more disks of the virtual machine for the guest operating system upon startup of the guest operating system on the virtual machine in response to the change in the host hypervisor of the virtual machine. Other embodiments are described and claimed.

### RELATED CASES

This application claims the benefit of priority under 35 U.S.C. §120 to U.S. patent application Ser. No. 14/296,695, titled “Techniques for Virtual Machine Migration,” filed on Jun. 5, 2014, which claims the benefit of priority under 35 U.S.C. §119(e) to U.S. Provisional Patent Application No. 61/992,108, filed on May 12, 2014, both of which are hereby incorporated by reference in their entirety.

This application is related to U.S. patent application Ser. No. 13/796,010, titled “Technique for Rapidly Converting Between Storage Representations in a Virtualized Computing Environment,” filed on Mar. 12, 2013, which is hereby incorporated by reference in its entirety.

### BACKGROUND

A virtual machine (VM) is a software implementation of a machine, such as a computer, that executes programs like a physical machine. A VM allows multiple operating systems to co-exist on a same hardware platform in strong isolation from each other, utilize different instruction set architectures, and facilitate high-availability and disaster recovery operations. Migrating data between VM architectures, however, may be problematic. For instance, migration may cause a disruption in services, lengthy migration times, or in some cases lead to data corruption.

### BRIEF DESCRIPTION OF THE DRAWINGS

FIG. 1 illustrates an embodiment of a virtual machine migration system.

FIG. 2 illustrates an embodiment of an overall logic flow for the virtual machine migration system of FIG. 1.

FIG. 3 illustrates an embodiment of a detailed logic flow for the VM prep stage of the overall logic flow of FIG. 2.

FIG. 4 illustrates an embodiment of a detailed logic flow for the migration stage of the overall logic flow of FIG. 2.

FIG. 5 illustrates a second embodiment of a virtual machine migration system.

FIG. 6 illustrates an embodiment of a first and second script executing in the guest operating system for the virtual machine migration system.

FIG. 7 illustrates an embodiment of a logic flow for the virtual machine migration system of FIG. 1.

FIG. 8 illustrates an embodiment of a logic flow for the self-repairing configuration service of FIG. 1.

FIG. 9 illustrates an additional embodiment of a logic flow for the self-repairing configuration service of FIG. 1.

FIG. 10 illustrates an additional embodiment of a logic flow for the self-repairing configuration service of FIG. 1 for the VM prep stage of the overall logic flow of FIG. 2.

FIG. 11 illustrates an additional embodiment of a logic flow for the self-repairing configuration service of FIG. 1 for the migration stage of the overall logic flow of FIG. 2.

FIG. 12 illustrates an embodiment of a centralized system for the virtual machine migration system of FIG. 1.

FIG. 13 illustrates an embodiment of a distributed system for the virtual machine migration system of FIG. 1.

FIG. 14 illustrates an embodiment of a computing architecture.

FIG. 15 illustrates an embodiment of a communications architecture.

### DETAILED DESCRIPTION

Various embodiments are generally directed to a self-repairing configuration service for virtual machine migration. Some embodiments are particularly directed to a to a self-repairing configuration service (or agent) for a guest operating system executing on a virtual machine. The self-repairing configuration service to detect a guest operating system executing on the virtual machine, detect a change to a host hypervisor of the virtual machine, and reconfigure one or more network interfaces and one or more disks of the virtual machine for the guest operating system upon startup of the guest operating system on the virtual machine in response to the change in the host hypervisor of the virtual machine.

Various embodiments for the self-repairing configuration service in relation to an automated virtual machine migration that is either fully-automated or makes use of only minimal human interaction, limited to, for example, bridging physical isolation or logical separation between a virtual machine environment and a control system. A guest operating system (OS) runs on top of an execution environment platform known as the virtual machine (VM), which abstracts a hardware platform from the perspective of the guest OS. The abstraction of the hardware platform, the providing of the virtual machine, is performed by a hypervisor, also known as a virtual machine monitor, which runs as a piece of software on a host OS. The host OS typically runs on an actual hardware platform, though multiple tiers of abstraction may be possible. While the actions of the guest OS are performed using the actual hardware platform, access to this platform is mediated by the hypervisor. For instance, virtual network interfaces may be presented to the guest OS that present the actual network interfaces of the base hardware platform through an intermediary software layer. The processes of the guest OS and its guest applications may execute their code directly on the processors of the base hardware platform, but under the management of the hypervisor.

Multiple vendors provide hypervisors for the execution of virtual machines using abstraction technology unique to the vendor's implementation. The vendors use technology selected according to their own development process. However these are frequently different from vendor to vendor. Consequently, the guest OS has tailored virtual hardware and drivers to support the vendor implementation. This variation may lead to a core incompatibility between VM platforms. For example, different VM platforms may use different technologies for bridging to a network, where virtualized network interfaces are presented to the guest OS. Similarly, different VM platforms may use different formats for arranging the data stored in virtual disks onto actual storage hardware. As such, migrating a guest OS from one VM platform to another may require reconfiguration of the guest OS and modification of files stored on the host OS that are referenced by the hypervisor. Performing this reconfiguration and modification may improve the affordability and practicality of transitioning a virtual machine between VM platforms.

It may be of particular value to perform virtual machine migration using a self-repairing configuration service without the installation of additional software tools, besides those that may be used for integration of the guest OS with the VM platform. For instance, the migration process may include the installation of integration tools, including drivers that provide support for the virtualized hardware devices of the destination VM platform to the guest OS. However, the migration itself may be performed entirely through scripts executed in the guest OS and remote commands from an external migration application, the migration application running on the host OS without virtual machine mediation. Avoiding the installation of migration tools within the guest OS may increase the dependability of the migration process, reduce the footprint of the software used for the migration, and reduce the time used for the migration process, thereby reducing the downtime for the guest OS and any services it may host.

Also, it may be of particular value to perform virtual machine migration without requiring VM credentials for migrating from one hypervisor to an alternative hypervisor. In other words, various embodiments described herein perform virtual machine migration without requiring an administrator or user, to provide VM credentials, store those credentials by the VM machine, and then use those credentials for migrating from one hypervisor to an alternative hypervisor. For instance, executing the virtual migration entirely through scripts executed in the guest OS and remote commands from an external migration application may be in part, or entirely, replaced by using a self-repairing configuration service (and/or an agent herein after “agent”) to perform virtual machine migration. Unlike the executing the virtual migration entirely through scripts executed in the guest OS and remote commands from an external migration application, which requires being specifically triggered, called, and then executed, the self-repairing configuration service automatically detects a guest operating system executing on the virtual machine, automatically detects a change to a host hypervisor of the virtual machine, and automatically reconfigures one or more network interfaces and one or more disks of the virtual machine for the guest operating system upon startup of the guest operating system on the virtual machine in response to the change in the host hypervisor of the virtual machine.

In one embodiment, the self-repairing configuration service is continuously executing for the guest operating system running on a virtual machine by collects a universally unique identifier (UUID) upon shutdown of the guest operating system on the virtual machine, and reconfigures one or more network interfaces and one or more virtual machine disks of the virtual machine for the guest operating system if a change to a host hypervisor, providing the virtual machine, is detected upon startup of the guest operating system on the virtual machine. More specifically, at every shutdown of the guest OS, the self-repairing configuration service collects all network and disk (e.g., VM disk) information for the VM machine, as well as, an identifier of the VM environment, such as the basic input/output system (BIOS) universally unique identification (UUID). Thus, at each time the guest OS shuts down, all the information needed to self-configure/repair in the destination format is captured. This identifier information is saved with the appropriate automation and configuration management framework, such as PowerShell (Windows®), command-line interpreter/shell (such as Bash), and/or other scripting language (in UNIX/Linux) in a configuration folder. The use of the self-repairing configuration service (agent) may eliminate the need for the scripts, but the scripts may be used/retained to allow a user to execute them manually at a later date.

Additionally, every time the guest OS starts up, the agent will re-check the guest OS identifier, such as the BIOS UUID. For example, if the BIOS UUID is the same as is stored in the configuration file, then the agent stops performing any actions until the next shutdown. If the BIOS UUID is different than the one stored in the configuration file, the agent will execute the Network and Disk rehydration scripts as the VM has been Shifted. In short, a determination is made each time the guest OS starts up whether or not a host hypervisor platform has moved or changed. If the hypervisor platform has changed, the automatic self configuration/repair function is executed by reconfiguring one or more network interfaces and one or more disks of the virtual machine for the guest operating system upon startup of the guest operating system on the virtual machine in response to this change in the host hypervisor (e.g., the change in the BIOS UUID) of the virtual machine. As such, the self-repairing configuration service that is associated with and/or integrated within the guest operating system running on the virtual machine becomes more robust and scalable since any specific integration required per hypervisor vendor is eliminated. Also, the self-repairing configuration service performs the virtual machine migration without needing to acquire or know all of the credentials for the hardware components or machines trying to be converted to a new hypervisor platform since there is no need to login as an administrator and perform any required configuration actions.

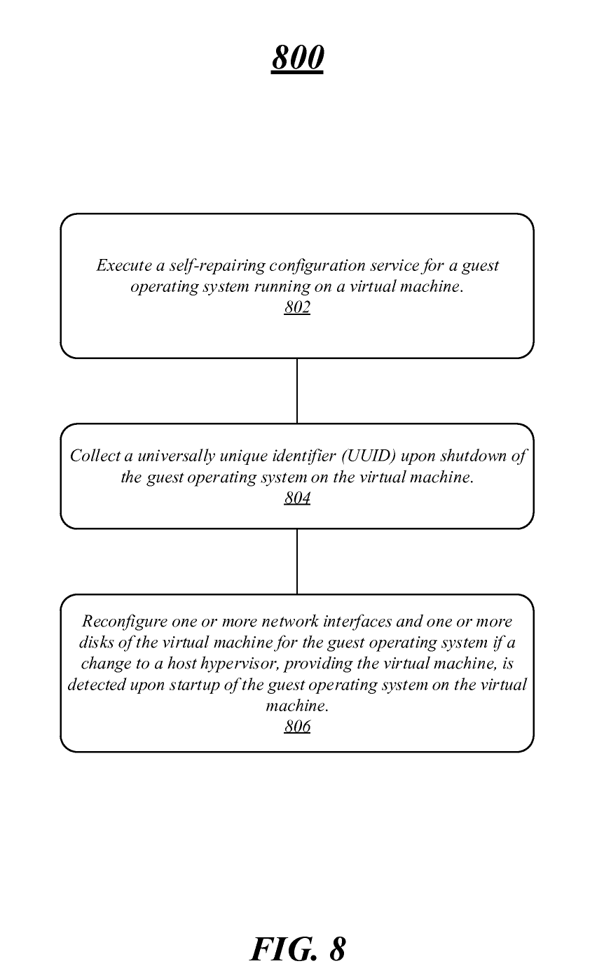

The self-repairing configuration service is a self-repairing operation capable of surviving different hypervisor platforms by automatically determining when a hypervisor platform has changed. Upon detecting the change to the hypervisor platform, the self-repairing configuration service automatically reconfigures from a pervious configuration or a new, alternative configuration, without requiring VM credentials, for one or more network interfaces and one or more disks of the virtual machine for the guest operating system upon startup of the guest operating system on the virtual machine in response to the change in the host hypervisor of the virtual machine. The self-repairing configuration service (or “agent”) is continuously executing (e.g., always turned on) for the guest operating system and does not require external assistance either from an automated system or any type of administrator. The self-repairing configuration service (or “agent”) is independent and performs the self-repairing configuration service based on the rules or instructions provided as described herein (e.g., see FIG. 8-11). Thus, the invention solves the problem of requiring VM credentials for migrating from one hypervisor to an alternative hypervisor.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

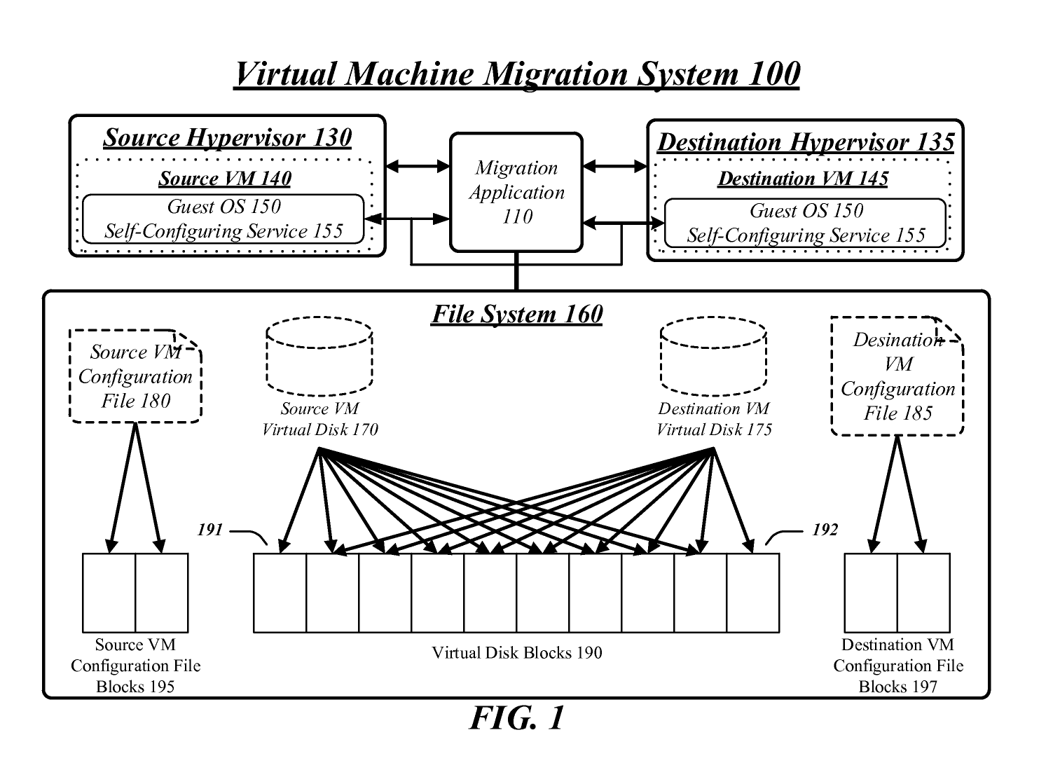

FIG. 1 illustrates a block diagram for a virtual machine migration system 100. In one embodiment, the virtual machine migration system 100 may comprise a computer-implemented system having a software migration application 110 comprising one or more components. Although the virtual machine migration system 100 shown in FIG. 1 has a limited number of elements in a certain topology, it may be appreciated that the virtual machine migration system 100 may include more or less elements in alternate topologies as desired for a given implementation.

It is worthy to note that “a” and “b” and “c” and similar designators as used herein are intended to be variables representing any positive integer. Thus, for example, if an implementation sets a value for a=5, then a complete set of components 122-a may include components 122-1, 122-2, 122-3, 122-4 and 122-5. The embodiments are not limited in this context.

The virtual machine migration system 100 may comprise the migration application 110. The migration application 110 may be generally arranged to migrate guest OS 150 from source VM 140 running on source hypervisor 130 to destination VM 145 running on destination hypervisor 135, wherein each of migration application 110, source hypervisor 130, and destination hypervisor 135 all run on top of host OS 120.

File system 160 may store various files used in the operation of source VM 140 and destination VM 145, and thereby the operation of guest OS 140. File system 160 may store various files used by migration application 110. File system 160 may store various files used by the host OS 120. File system 160 may be provided by host OS 120 or may be a third-party file system working in conjunction by host OS 120. File system 160 may be a local file system, a network-accessible file system, a distributed file system, or use any other file system techniques for the storage of, maintenance of, and access to files.

File system 160 may store source VM configuration file 180 used by source hypervisor 130 for the determination of various configurations of source VM 140. File system 160 may store destination VM configuration file 185 used by destination hypervisor 130 for the determination of various configurations of source VM 140. Source VM configuration file 180 may be composed of one or more source VM configuration file blocks 195. Destination VM configuration file 185 may be composed of one or more destination VM configuration file blocks 197. The configuration of a virtual machine may comprise, among other elements, specifying the configuration of the hardware platform to be virtualized, such as number and type of CPU, memory size, disk size, etc.

Guest OS 150 may be presented a virtual disk by the virtual machines, the virtual disk an abstraction of the physical storage used by the virtual machines. File system 160 may store source VM virtual disk 170, where source VM virtual disk 170 is an arrangement of blocks corresponding to a virtual disk format used by the source hypervisor 130. File system 160 may store destination VM virtual disk 175, where destination VM virtual disk 175 is an arrangement of blocks corresponding to a virtual disk format used by the destination hypervisor 135. Virtual disk blocks 190 is the joint collection of blocks used by both source VM virtual disk 170 and destination VM virtual disk 175. Source VM virtual disk 170 and destination VM virtual disk 175 may be able to be built from almost entirely the same set of blocks, with the common blocks being those that correspond to the storage of data visible to the guest OS 150. Each of the source VM virtual disk 170 and destination VM virtual disk 175 may have one or more blocks dedicated to storage of data and metadata used by the source hypervisor 130 and destination hypervisor 135, respectively, that is not accessible to the guest OS 150. For example, block 191 may be exclusively used by source hypervisor 130 for storing data and metadata used for managing its access to the common blocks of virtual disk blocks 190. Similarly, block 192 may be exclusively used by destination hypervisor 135 for storing data and metadata used for managing its access to the common blocks of virtual disk blocks 190. It will be appreciated that multiple blocks may be used by either or both of source hypervisor 130 and destination hypervisor 135 for the storage of this data and metadata. Because of this overlap in storage blocks transitioning from source hypervisor 130 to destination hypervisor 135 may involve simply creating block 192, with its data and metadata for managing the common blocks, and constructing destination VM virtual disk 175 from those blocks used by source VM virtual disk 170 that are not exclusive to the management data and metadata of source hypervisor 130.

A self-repairing configuration service component or “agent” may be installed in the guest OS 150 or may be a separate component in association with the guest OS 150 and also may be in communication with a host hypervisor 130 or 135. The self-repairing configuration service (or agent) 155 is controlled by a processor device and executes self-repairing configurations as described herein. The self-repairing configuration service 155 may interact with the source hypervisor 130, the destination hypervisor 135, the guest OS 150, and the file system 160 to reconfigure the guest OS 150 after detecting a change from the source hypervisor 130 to the destination hypervisor 135 or visa versa. In one embodiment, the self-repairing configuration service agent 155 bypasses or eliminates the need for the migration application 110. When possible, the self-repairing configuration service agent 155 is automatically pushed and installed into the guest OS 150 when the guest OS 150 credentials are known, otherwise the installation is performed by a user knowing the guest OS 150 credentials. Also, the in-guest utilities/tools may function as, and/or assist with, the self-repairing configuration service agent 155 to eliminate and/or reduce the need for customized software.

The migration application 110 may interact with the source hypervisor 130, the destination hypervisor 135, the guest OS 150, and the file system 160 to migrate the guest OS 150 from the source hypervisor 130 to the destination hypervisor 135. The migration application 110 may generate one or more scripts that run in the guest OS 150 running on top of each of the source VM 140 and the destination VM 145 to perform the migration. The migration application 110 may use one or more scripts that run in the guest OS 150 on top of the source VM 140 to gather configuration information for use in generation of one or more scripts that run in the guest OS 150 on top of destination VM 145. The migration application 110 may send commands to and monitor the source hypervisor 130 and destination hypervisor 135. For instance, the migration application 110 may script or use direct commands to initiate power cycles of the virtual machines and use the power cycling of virtual machines to monitor the progress of scripts. By using scripts that use the built-in scripting of the guest OS 150 the migration application 110 may avoid installing software agents within the guest OS 150 for performing the migration, thereby simplifying the migration process.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

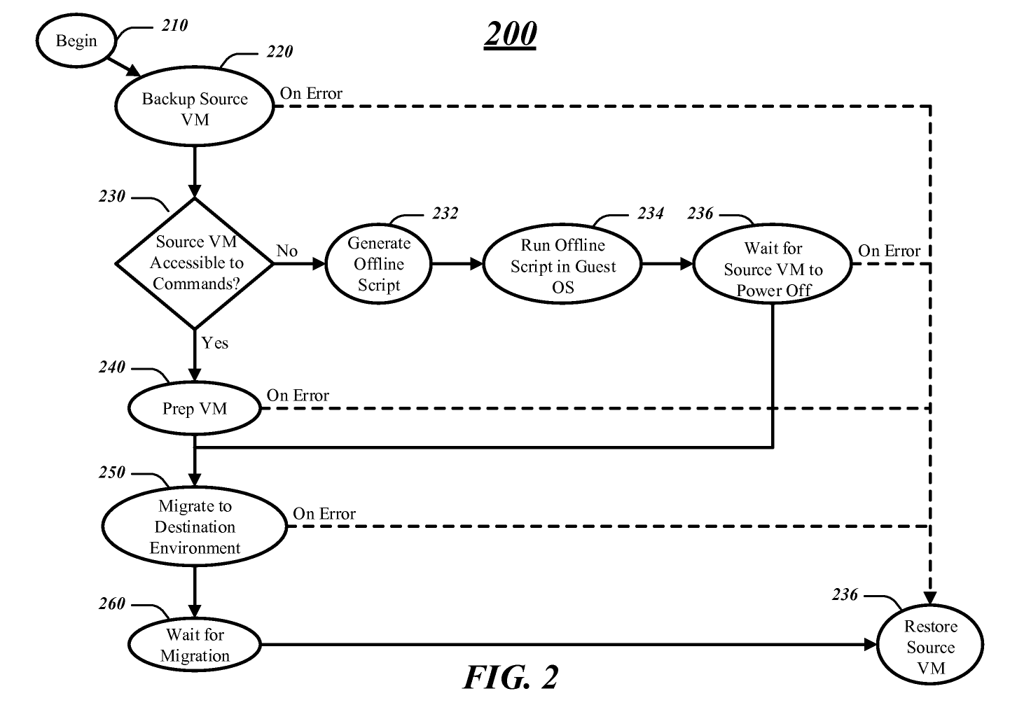

FIG. 2 illustrates one embodiment of a logic flow 200. The logic flow 200 may be representative of some or all of the operations executed by one or more embodiments described herein. The logic flow 200 may be an overall logic flow for the virtual machine migration system 100, presenting a high-level view of the workflow of the migration process.

In the illustrated embodiment shown in FIG. 2, the logic flow 200 may begin at block 210. This may correspond to the initiation of a virtual machine migration for a particular instantiation of a guest OS. In some cases, the logic flow 200 may be initiated manually be an administrator of a computer system. In others, the logic flow 200 may be initiated programmatically as part of a group of migrations. For example, a plurality of guest OS installations may all be migrated from one hypervisor to another with an automated process automatically migrating each one in turn or in parallel. The logic flow 200 then proceeds to block 220.

The logic flow 200 may back up the source VM 140 at block 220. Errors may occur during the migration process—from bugs, from some unusual element of the VM environment not accounted for in the migration application 110, etc. When this occurs it is beneficial to have the option to restore the source VM 140. If an error occurs during the backup source VM process itself the logic flow 200 may proceed to block 236 where the source VM 140 is attempted to be restored. Otherwise, the logic flow 200 may continue to block 230.

The logic flow 200 may determined whether the source VM 140 is accessible to automated commands at block 230. If the source VM 140 is accessible then the migration application 110 can initiate scripts within the guest OS 150 within the source VM 140, and the logic flow 200 proceeds to box 240. If the source VM 140 is not accessible then the migration application 110 will generate an offline script and hand that script off to a human operator to run in the guest OS 140, and the logic flow 200 proceeds to box 232.

The logic flow 200 may generate an offline script at box 232. This offline script contains all of the work that needs to be done by the migration application 110 in the guest OS 150 in the source VM 140. The logic flow 200 then proceeds to box 234.

The logic flow 200 may run the offline script in the guest OS 150 in the source VM 140 at box 234. While the activity of the offline script is performed programmatically through the scripting application programming interface (API) of the guest OS 150, the transfer of the offline script into the guest OS 150 and the initiation of it are performed by a human operator. The logic flow 200 then proceeds to box 236.

The logic flow 200 may wait for the source VM 140 to power off at box 236. The final operation of the offline script is to power-down the source VM 140—stopping execution of the virtual machine by the physical host. The migration application 110 waits for this powered-off state in order to know that the offline script has completed. If an error occurs the logic flow 200 proceeds to block 236. Otherwise, the logic flow 200 proceeds to block 250.

The logic flow 200 may prepare the source VM 140 at block 240. The preparation of the source VM 140 may generally correspond to the functions of the offline script, but initiated programmatically by the migration application 110 and performed in stages rather than unified into a single offline script. Initiating the script in the guest OS 150 may comprise using a remote administration API of the guest OS 150 or may comprise using a remote administration API of the source hypervisor 130. If an error occurs the logic flow 200 proceeds to block 236. Otherwise, the logic flow 200 proceeds to block 250.

The logic flow 200 may migrate the guest OS 150 to the destination environment provided by the destination hypervisor 135 at block 250. While all of the described steps of logic flow 200 are part of the migration process, box 250 corresponds to the actual transition of configuration information from one environment to another. If an error occurs the logic flow 200 proceeds to block 236. Otherwise, the logic flow 200 proceeds to block 260.

The logic flow 200 may include the migration application 110 waiting for the migration to complete at block 260. As the migration makes use of scripts that run within the guest OS 150 running on the destination VM 145 the migration application 110 may not be able to directly monitor the progress of the scripts and instead depend on the power cycling of the destination VM 145 to monitor whether the scripts have completed. The logic flow 200 then proceeds to box 236.

The logic flow 200 may restore the source VM 140 at block 236. This restoration allows for a return to the original source VM 140 run by the source hypervisor 130 in case, for example, a problem develops with the destination VM 145. With this step complete the migration application 110 may have completed its task or may continue with the migration of other virtual machines. The embodiments are not limited to this example.

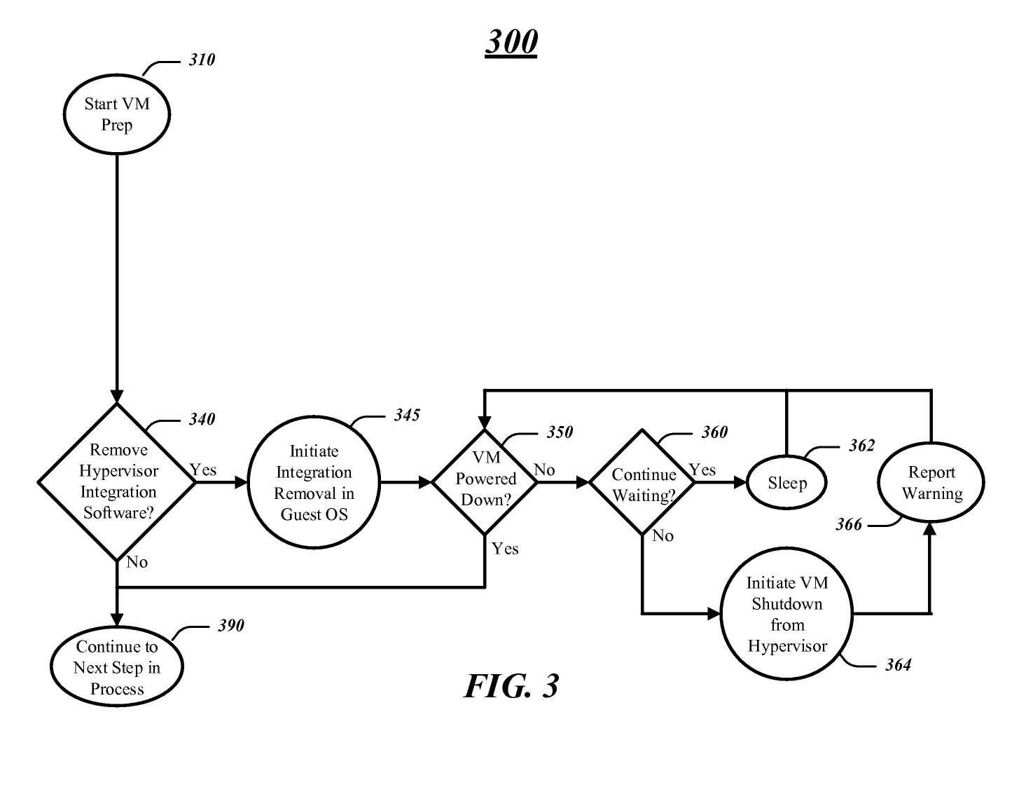

FIG. 3 illustrates one embodiment of a logic flow 300. The logic flow 300 may be representative of some or all of the operations executed by one or more embodiments described herein. The logic flow 300 may be an detailed logic flow for the VM prep stage of the overall logic flow 200 of FIG. 2.

In the illustrated embodiment shown in FIG. 3, the logic flow 300 may begin at block 310. This may correspond to the transition of the overall logic flow 200 into block 240 of FIG. 2. The logic flow then proceeds to block 340.

The logic flow 300 may determine whether to remove integration software for the source hypervisor 130 from the guest OS 150 at block 340. In some cases, the administrators of the computing system may desire to keep existing integration tools and services installed in order to allow transition back to the source VM 130. In some cases, transitioning back to the source VM 130 may be motivated by eventual dissatisfaction with the destination VM 145 or may be motivated by the use of software applications on top the guest OS 150 where one or more only work or work better on the source VM 140 and one or more only work or work better on the destination VM 145. Alternatively, the removal of hypervisor integration software may be unnecessary due to hypervisor integration software not being used with the source hypervisor 130. Whatever the reason, if hypervisor integration software is to be removed the logic flow 300 proceeds to block 345. Otherwise, the logic flow 300 proceeds to block 390.

The logic flow 300 may initiate removal of the integration software in the guest OS 150 at block 345. This may be performed by initiating the running of a script within the guest OS 150. This script may conclude with a command to power down the source VM 140 to indicate that the script has completed its task. As this removal occurs after creation of the cloned backup disk, the restoration of the source VM virtual disk 170, if performed, will restore these tools. The logic flow 300 may then proceed to block 350.

The logic flow 300 may check with the source VM 140 has powered down at block 350. If so, the hypervisor tools and services have been successfully removed and the logic flow 300 may proceed to block 390. Otherwise, the logic flow 300 proceeds to block 360.

The logic flow 300 may determine whether to continue waiting for the source VM 140 to power down at block 360. The migration application 110 may have a limit to how long it will wait for the tools to be removed as measured by a watchdog timer. If that limit has not been reached the logic flow 300 may proceed to block 362. If it has been reached the logic flow 300 may proceed to block 364.

The logic flow 300 may have the migration application 110 sleep at block 362. This may consist of a timed period of inactivity—such as may be registered with the host OS 120—to give the source VM 140 more time to power down. The logic flow 300 may then loop back to block 350.

The logic flow 300 may initiate shutdown of the source VM 140 with the source hypervisor 130 at block 364. If the watchdog timer has expired the migration application 110 has reached the point where it is no longer willing to wait for the guest OS 150 to shut down the source VM 140 on the basis of the integration software removal script. As such, the migration application 110 directly commands the source hypervisor 130 to stop the source VM 140. The logic flow 300 then proceeds to block 366.

The logic flow 300 may report a warning at block 366. Having forced the source VM 140 to power down from the hypervisor may leave the guest OS 150 in a unclean or otherwise problematic state. This warning reports to an administrator of the migration application 110 of this possibility. The logic flow may then proceed back to block 350 to check for the source hypervisor 130 having powered down the source VM 140.

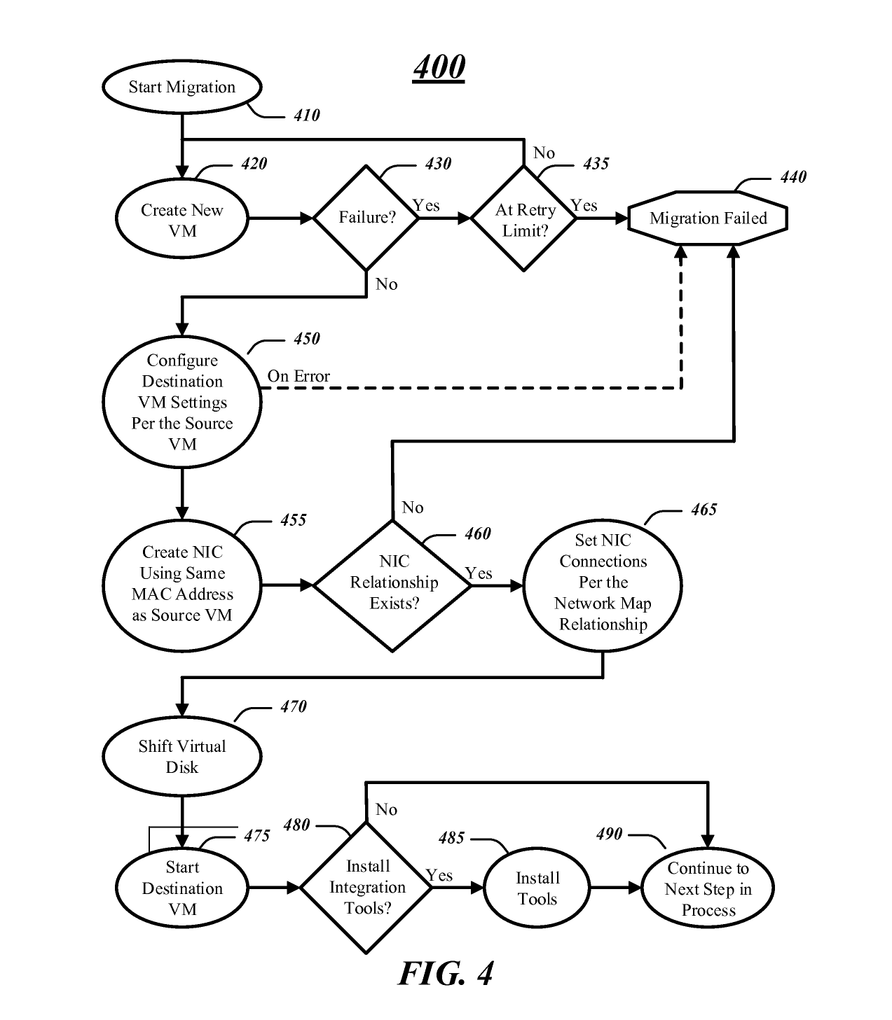

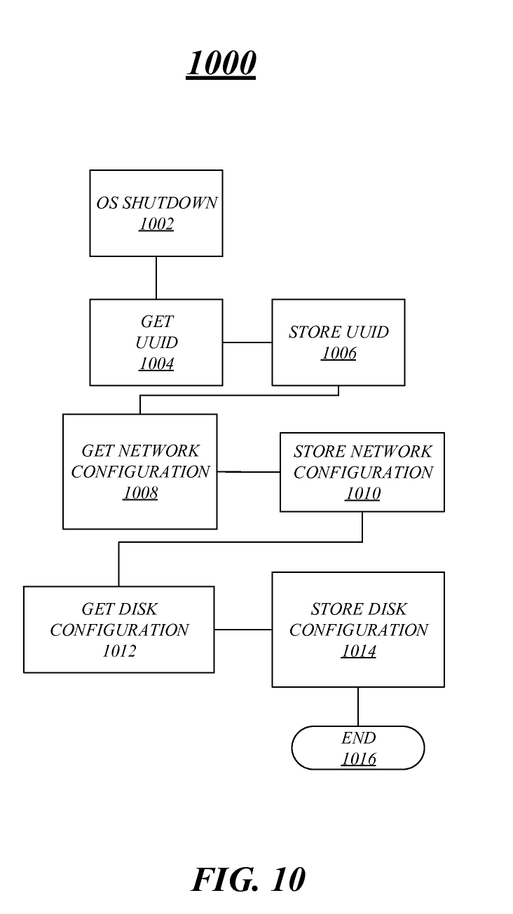

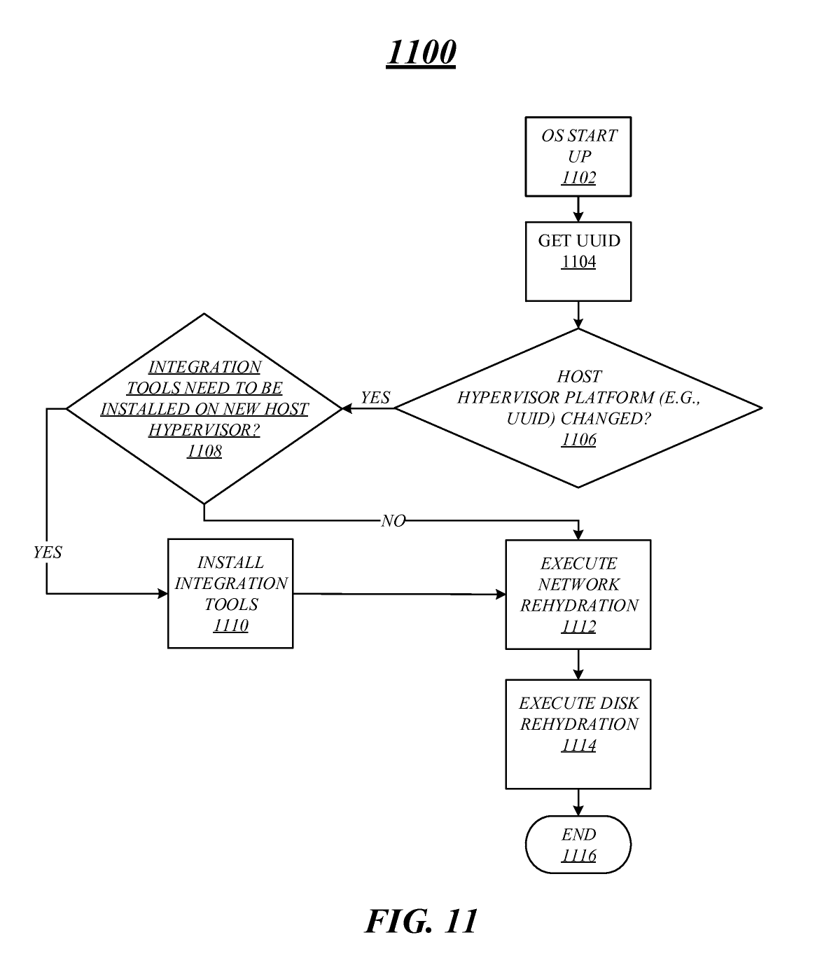

The logic flow 300 may continue to the next step in the overall process at block 390. This may correspond to the transition of the overall logic flow 200 out of block 240 of FIG. 2. The logic flow 300 illustrate the migration appliance 110 no longer needs to orchestrate a VM guest configuration migration. Rather, the migration appliance 110 removes any integration components, and then shuts down the guest OS 150. When the guest OS 150 shuts down, the guest OS 150 runs the workflow illustrated in FIG. 10. The source VM 140 is migrated using the workflow in FIG. 4. When the source VM 140 is started on a new hypervisor, e.g., the destination VM 145, the guest OS 150 will run the workflow documented in FIG. 11. By making the guest OS 150 intelligent and able to self-repair. the migration appliance 110 may send the source VM 140 to one or more destination VMs 145 and the guest OS 150 will automatically fix itself and in so doing removes the complexity of the VM migration while actually increasing the capability of the virtual machine migration system 100.

The embodiments are not limited to this example.

FIG. 4 illustrates one embodiment of a logic flow 400. The logic flow 400 may be representative of some or all of the operations executed by one or more embodiments described herein. The logic flow 400 may be an detailed logic flow for the migration stage of the overall logic flow 200 of FIG. 2.

In the illustrated embodiment shown in FIG. 4, the logic flow 400 may begin at block 410. This may correspond to the transition of the overall logic flow 200 into block 250 of FIG. 2. The logic flow then proceeds to block 420.

The logic flow 400 may create a new virtual machine, the destination VM 145, at block 420. This may be created on the same physical hardware as the source VM 140 or at new physical hardware. The logic flow 400 then proceeds to block 430.

The logic flow 400 may determine whether the creation of destination VM 145 has failed at block 430. In some cases errors may occur in the VM-creation process and the process may have to be attempted multiple times. If the VM creation failed then the logic flow 400 proceeds to block 435. Otherwise, the logic flow 400 proceeds to block 450.

The logic flow 400 may determine whether the migration application 110 has reached its retry limit at block 435. The migration application 110 may be configured to only attempt VM creation a limited number of times in order to forestall a potentially infinite loop. If it is at the retry limit, the logic flow 400 may then proceed to block 440. If the retry limit has not been reached then the logic flow 400 may loop back to block 420 and re-attempt the creation of destination VM 145.

The logic flow 400 may determine that migration has failed at block 440. With the VM creation retry limit reached, or configuration of the destination VM 145 having failed, the migration is not successful. The migration application 110 may indicate this failure to an administrator of the application. The migration application 110 may proceed to restore the source VM 140, as following the “on error” path from block 250 of FIG. 2.

The logic flow 400 may configure the destination VM 145 settings per the source VM 140 settings at block 450. For example, the destination VM 145 may be configured to have the same number of CPUs, same amount of RAM, and other virtualized hardware configurations as with the source VM 140 so as to provide as much continuity of virtualized hardware platform as possible to the guest OS 150. If an error occurs during this process the logic flow 400 may proceed to block 440. If this process completes successfully the logic flow 400 may proceed to block 455.

The logic flow 400 may create one or more network interface controllers (NICs) in the destination VM 145 using the same media access control (MAC) addresses as in the source VM 140 at block 455. These NICs are virtualized network adaptors used by the destination hypervisor 135 to bridge real network interfaces to the guest OS 150 when running on the destination VM 145. By configuring the destination VM 145 with the same MAC addresses as used with the source VM 140 the guest OS 150 will be able to be configured by scripts running within the guest OS 150 to match up internal network connections for the OS with the virtualized network adaptors. If new MAC addresses were assigned then the scripts may be unable to determine which NIC should be connected with which internal connections for the guest OS 150 as programs running within the guest OS 150 don't have visibility to the actual network configuration of the host OS 120. The logic flow 400 then proceeds to block 460.

The logic flow 400 determines whether it has access to a NIC relationship map at block 460. The NIC relationship map is a simple one for one relational link between the various host operating systems, which may be used where a different host operating system is used for the source VM 140 and the destination VM 145. Since each hypervisor employs a specialized network implementation it is valuable to maintain a key. If an appropriate map is found then the destination VM NIC is connected to the appropriate network on the destination host OS. If it does not, it cannot configure the network and the logic flow 400 proceeds to block 440. If it does, the logic flow 400 proceeds to block 465.

The logic flow 400 sets NIC connections per the network map relationship at block 465. Connections between the guest OS 150 are configured to the virtualized NICs based on the preconfigured relational mapping. The network connections of the guest OS 150 are rebuilt such that each internal connection connects to the virtualized NIC with the same MAC address as that internal connection was connected to when the guest OS 150 was in the source VM 140. The logic flow 400 then proceeds to block 470.

The logic flow 400 may shift the virtual disk at block 470. This may correspond to the creation of the destination VM virtual disk 175 through the creation of one or more new header, footer, or other metadata blocks for the virtual disk blocks 190 of the source VM virtual disk 170. The logic flow 400 then proceeds to block 475.

The logic flow 400 may start the destination VM 145 at block 475. This may comprise sending a power-on command to the destination hypervisor 135. The logic flow 400 then proceeds to block 480.

The logic flow 400 may determine whether to install integration tools and services at block 480. This determination may be an inherent consequence of whether the guest OS 150 was configured to automatically install integration tools and services for the destination hypervisor 135 at its next boot at block 432 of FIG. 4. If this boot configuration was performed, the logic flow 400 proceeds to block 485. Otherwise, the logic flow 400 proceeds to block 490.

The logic flow 400 may install integration tool and services in the guest OS 150 at block 485. This may be performed automatically by scripts initiated at boot by the guest OS 150. The logic flow 400 then proceeds to block 490.

The logic flow 400 may continue to the next step in the overall process at block 490. This may correspond to the transition of the overall logic flow 200 out of block 250 of FIG. 2.

The embodiments are not limited to this example.

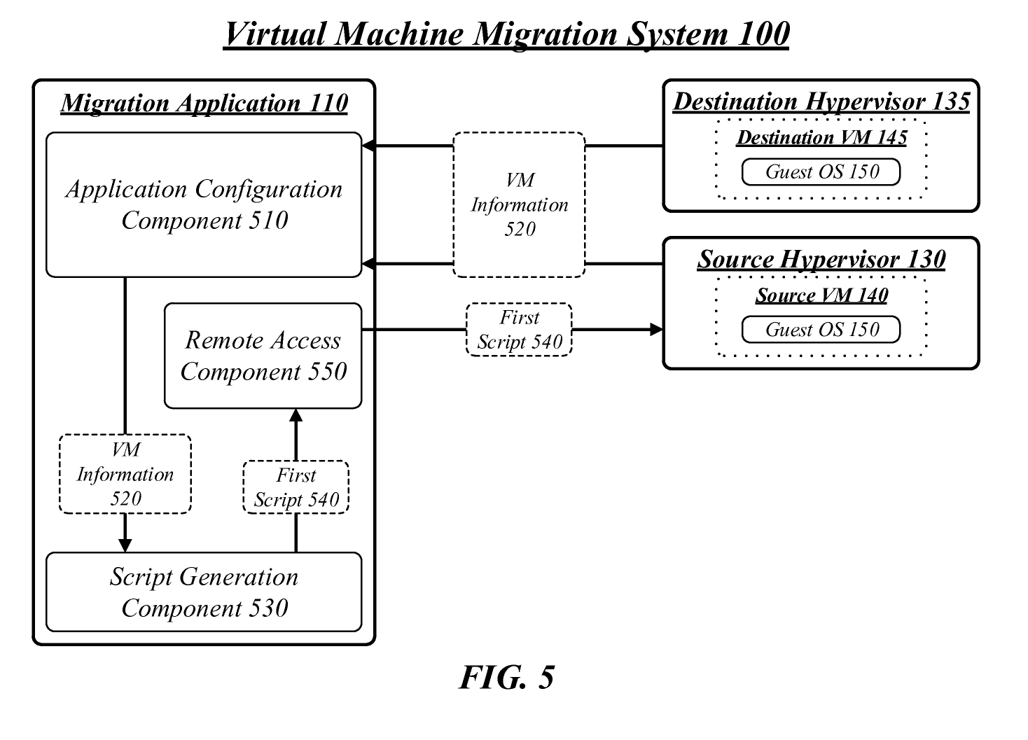

FIG. 5 illustrates a second block diagram for the virtual machine migration system 100. In one embodiment, the virtual machine migration system 100 may comprise a computer-implemented system having a migration application 110 comprising one or more components. Although the virtual machine migration system 100 shown in FIG. 5 has a limited number of elements in a certain topology, it may be appreciated that the virtual machine migration system 100 may include more or less elements in alternate topologies as desired for a given implementation.

The system 100 may comprise the migration application 110. The migration application 110 may be generally arranged to oversee the deployment of one or more scripts to a guest OS 150 to migrate the guest OS 150 from a source VM 140 provided by a source hypervisor 130 to a destination VM 145 provided by a destination hypervisor 135. The migration application 110 may comprise an application configuration component 510, script generation component 530, and a remote access component 550.

The application configuration component 510 may be generally arranged to request VM information 520 from the source hypervisor 130 and destination hypervisor 135. This may comprise use an API for the hypervisors 130, 135 to retrieve information relevant to the generation of scripts specific to the source hypervisor 130, destination hypervisor 135, the source VM 140, destination VM 145, and guest OS 150. The application configuration component 510 may receive the VM information 520 from the source hypervisor 130 and destination hypervisor 135 and pass the VM information 520 to the script generation component 530.

In some embodiments, the collecting of information about some or all of the source hypervisor 130, destination hypervisor 135, the source VM 140, destination VM 145, and guest OS 150 may be irrelevant to the generation of the migration scripts. As such, the application configuration component 510 may only collect such information as relevant to that embodiment. In some embodiments, the migration scripts may be generated without the VM information 520 being collected from the hypervisors 130, 135. In these embodiments, the particular hypervisors 130, 135 and guest OS 150 being used—for example, a product name for the hypervisors 130, 135 and guest OS 150—may be specified during a configuration of migration application 110 by an administrator of the virtual machine migration system 100.

The script generation component 530 may be generally arranged to generate a first script 540, the first script 540 to migrate a guest OS 150 running on a source VM 140 to run on a destination VM 145. The source VM 140 may be provided by a source hypervisor 130 and the destination VM 145 may be provided by a destination hypervisor 135. The source hypervisor 130 and the destination hypervisor 135 may differ in hardware virtualization as to prevent the guest OS 150 from making full use of the destination VM 145 without reconfiguration. For instance, the guest OS 150 may be able to boot and run scripts on the destination VM 145 without reconfiguration, but be unable to access any or all of one or more networks provided by the destination VM 145 without reconfiguration by the virtual machine migration system 100. In general, the guest OS 150 being prevented from making full use of the destination VM 145 without reconfiguration may correspond to the guest OS 150 making use of one or more virtualized hardware resources of the source VM 140 that it is unable to make use of on the destination VM 145 without reconfiguration.

In some cases, the first script 540 may have its execution within the guest OS 150 initiated by the remote access component 550. In these cases, the first script 540 may be part of a plurality of scripts, wherein all of the plurality of scripts are executed within the guest OS 150. Each of the plurality of scripts may be associated with a particular area of reconfiguration, such as network reconfiguration, tools reconfiguration, etc. However, in some cases, the guest OS 150 may not be accessible to automated commands by the migration application 110. In these cases, the script generation component 530 may generate the first script 540 as an offline script operative for human-initiated execution. The first script 540 may be generated as an offline script in response to the remote access component 550 determining that source VM 140 is inaccessible to automated commands. The offline script may contain all of the scripted activities that would otherwise be performed by the plurality of scripts into a single script, to ease the process for the human operator manually loading it into the guest OS 150 and initiating it.

The script generation component 530 may generate the first script 540 using templates configured into the migration application 110. For instance, the migration application 110 may store script elements for the performance of various migration tasks, which may be specific to any individual or combination of particular tasks, particular guest operating systems, particular source hypervisors, particular destination hypervisors, and particular options selected by an administrator of the virtual machine migration system 100. The script element may include templates variables for which values may be assigned based on any individual or combination of particular tasks, particular guest operating systems, particular source hypervisors, particular destination hypervisors, and particular options selected by an administrator of the virtual machine migration system 100. In general, any known technique for generating a script, including any known technique for generating scripts based on templates, may be used.

The remote access component 550 may be generally arranged to command the guest OS 150 to execute the first script 540 using at least one of a remote access API of the guest OS 150 or a remote administration API of a source hypervisor 130 for the source VM 140. A remote access API of the guest OS 150 may be provided by the guest OS 150 for remote administration of the guest OS 150. A remote administration API of a source hypervisor 130 may be provided by the source hypervisor 130 for remote access to the guest OS 150 by providing a bridge between the environment external to the source VM 140 and the guest OS 150 within it.

Where neither such API exists, or, alternatively, where a particular API relied on by an embodiment of the virtual machine migration system 100 does not exist, the remote access component 550 may be operative to determine that that the source VM 140 is inaccessible to automated commands and report such to the script generation component 530 so as to indicate that an offline script should be generated. In other cases, the use of an offline script may be specified by an administrator of the virtual machine migration system 100, with the script generation component 530 producing the first script 540 as an offline script in response to the specification by the administrator rather than in response to a determination by the remote access component 550 that the source VM 140 is inaccessible to automated commands. Such configuration by the administrator may be performed even where the source VM 140 would be accessible to automated commands.

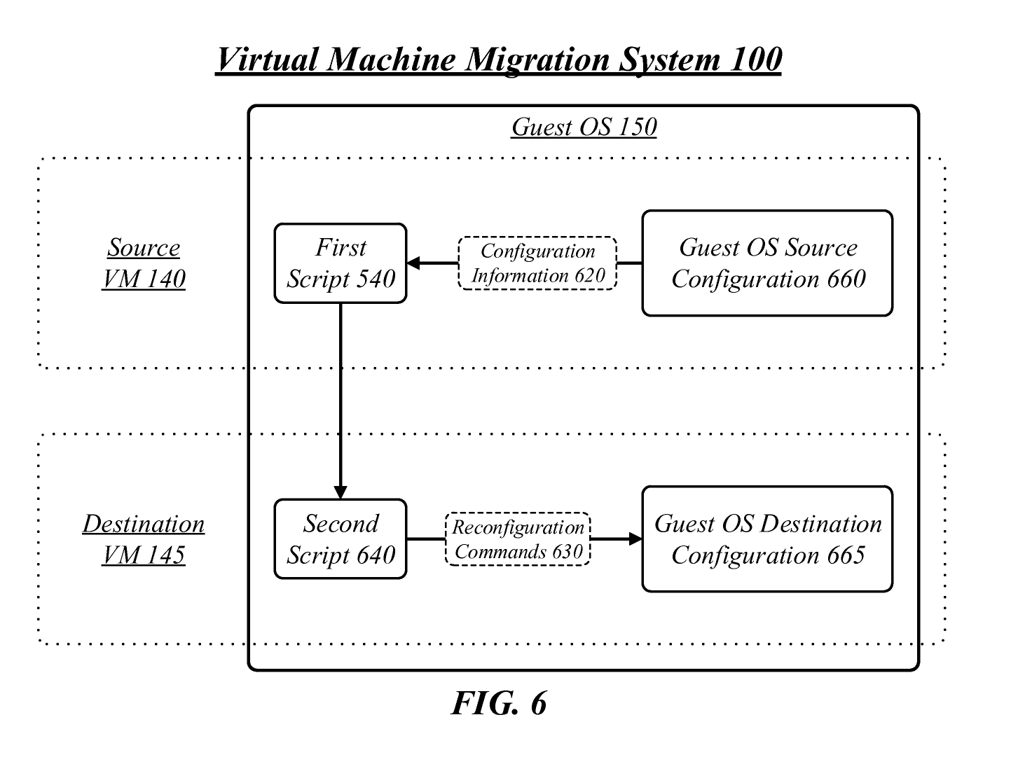

FIG. 6 illustrates an embodiment of a first script 540 and second script 640 executing in the guest OS 150 for the virtual machine migration system 100.

The first script 540 may be generally arranged to collect configuration information 620 of the guest OS 150 based on the current guest OS source configuration 660 while the guest OS 150 is running on the source VM 140. The first script 540 may collect the configuration information 620 by querying the guest OS 150, utilities of the guest OS 150, and configuration files of the guest OS 150.

The first script 540 may generate a second script 640 based on the collected configuration information 660. The first script 540 may generate the second script 640 using templates configured into the first script 540. For instance, the migration application 110 may store script elements for the performance of various migration tasks, which may be specific to any individual or combination of particular tasks, particular guest operating systems, particular source hypervisors, particular destination hypervisors, and particular options selected by an administrator of the virtual machine migration system 100. The script element may include templates variables for which values may be assigned based on any individual or combination of particular tasks, particular guest operating systems, particular source hypervisors, particular destination hypervisors, and particular options selected by an administrator of the virtual machine migration system 100. In general, any known technique for generating a script, including any known technique for generating scripts based on templates, may be used. The script elements relevant to the current migration may be made available to the first script 540 by the script generation component 530, which may include providing multiple potential elements that may be selected from by the first script 540 according to the collected configuration information 620.

The configuration information 620 may be collected while the guest OS 150 is running on the source VM 140. Collecting the configuration information 620 while the guest OS 150 is still running on the source VM 140 allows the collected configuration information 620 to be read from the guest OS source configuration 660 while it is operating correctly within the virtualized hardware environment provided by the source hypervisor 130.

The first script 540 may configure the guest OS 150 to execute the second script 640. The guest OS 150 may be configured for the execution of the second script 540 to occur while the guest OS 150 is running on the destination VM 145. As the second script 540 will be reconfiguring the guest OS 150 to properly run on the destination VM 145, this reconfiguration occurs while the guest OS 150 is running on virtualized hardware environment provided by the destination hypervisor 135. Because the virtualized hardware environment provided by the destination hypervisor 135 may differ from the virtualized hardware environment provided by the source hypervisor 130, the reconfiguration is best performed with access to the changes in environment presented by the new virtualized hardware environment of the destination VM 145 as the reconfiguration may be specific to the destination VM 145. The second script 640 may reconfigure the guest OS 150 using scripting-based reconfiguration commands 630 to create the guest OS destination configuration 665. The reconfiguration commands 630 may be encoded in the second script 640 by the first script 540 based on the configuration information 620. In some embodiments, the second script 640 may be part of a plurality of scripts generated by the first script 540, wherein the plurality of scripts are executed within the guest OS 150 running on top of the destination VM 145 based on the first script 540 configuring the guest OS 150 to execute them.

The first script 540 may configure the guest OS 150 to execute the second script 640 on a next booting up of the guest OS 150. The first script 540 may perform this configuration while the guest OS 150 is running on the source VM 140, after the configuration information 620 has been collected and the second script 640 generated. The first script 540 may then shut down the guest OS 150.

The remote access component 550 may monitor the source hypervisor 130 to determine when the guest OS 150 has shut down and, accordingly, the source VM 140 has moved to a virtualized power-off state. The remote access component 550 may monitor the source hypervisor 130 for the guest OS 150 shutting down in order to determine when the first script 540 has completed its tasks and has made the guest OS 150 ready to boot on top the destination VM 145. As such, when the remote access component 550 determines that the guest OS 150 has shut down on the source VM 140 it may then command the destination hypervisor 125 to boot up the guest OS 150 on the destination VM 145 in response.

In some cases, the guest OS 150 may fail to shut down when running on the source VM 140. As such, the migration application 110 may have a limited amount of time it is willing to wait for the first script 540 to complete. When this time has expired the remote access component 550 may instruct the source hypervisor 130 to force the shut down of the guest OS 150 by forcing the source VM 140 into a virtualized power-off state. While this risks leaving the guest OS 150 in an unsafe state, it may be preferable to allowing the guest OS 150 to indefinitely hang without shutting down. The migration application 110 may be configured to wait an amount of time estimated to be a sufficient amount of time for the first script 540 to collect the configuration information 620 and generate the second script 640. Once the guest OS 150 has been forced to shut down, the remote access component 550 may command the destination hypervisor 135 to boot up the guest OS 150 on top of the destination VM 145 in response.

In some cases, the configuration information 620 collected may include a mapping between one or more network interfaces of the source VM 140 and media access control (MAC) addresses assigned to the one or more network interfaces of the source VM 140. The second script 640 may reconfigure the guest OS 150 by creating associations between the guest OS 150 and one or more network interfaces of the destination VM 145 based on the mapping generated by the first script 540. The associations created by be based on the mapping by virtue of the second script 640 having been created by the first script 540 using the mapping in order to reproduce the association between internal network interfaces of the guest OS 150 and the MAC addresses to which they were assigned in the destination VM 145 as they were in the source VM 140. This may serve to resolve any networking complications created by using different technologies for virtualizing a network interface or using a different naming scheme for the virtualized network interfaces.

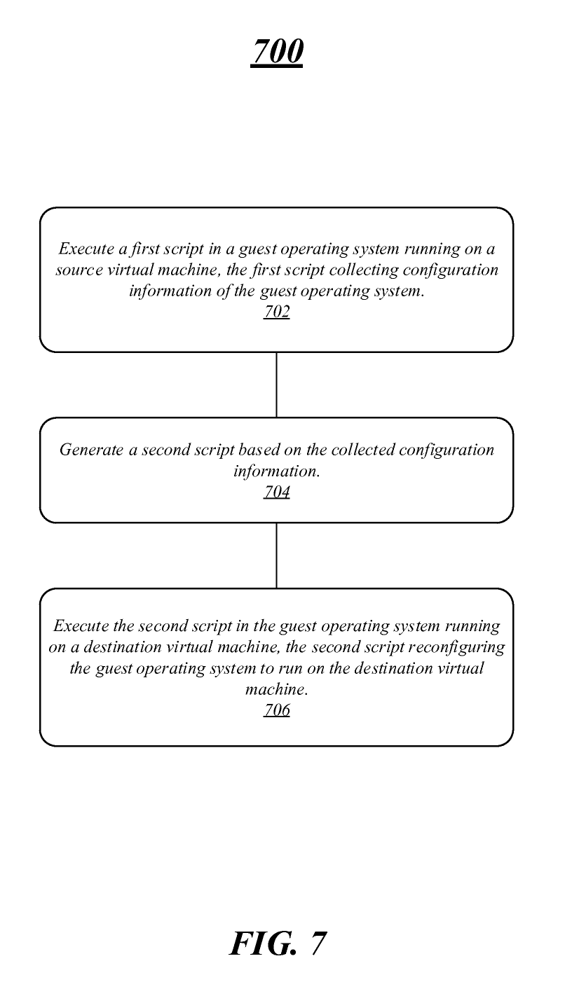

FIG. 7 illustrates one embodiment of a logic flow 700. The logic flow 700 may be representative of some or all of the operations executed by one or more embodiments described herein.

In the illustrated embodiment shown in FIG. 7, the logic flow 700 may start at block 702.

The logic flow 700 may execute a first script 540 in a guest OS 150 running on a source VM 140, the first script 540 collecting configuration information 620 of the guest OS 150 at block 704. The first script 540 may be executed in the guest OS 150 using at least one of a remote access API of the guest OS 150 or a remote administration API of a source hypervisor 130 for the source VM 140. Alternatively, it may be determined that the source VM 140 is inaccessible to automated commands, with the first script 540 generated as an offline script operative for human-initiated execution in response.

The source VM 140 may be provided by a source hypervisor 130, the destination VM 145 provided by a destination hypervisor 135, the source hypervisor 130 and destination hypervisor 135 differing in hardware virtualization as to prevent the guest OS 150 from making full use of the destination VM 135 without reconfiguration. In particular, the networking configuration of the guest OS 150 may be incompatible with the virtualized networking hardware presented to the guest OS 150 as part of the virtualized hardware environment of the destination VM 145.

The configuration information 620 collected may comprise a NIC-to-MAC mapping between one or more network interfaces of the source VM 140 and media access control addresses assigned to the one or more network interfaces of the source VM 140. This mapping may allow the logic flow 700 to recreate the associations between non-virtualized, physical NICs and the virtualized NICs of the virtualized hardware environment despite changes in how the virtualized hardware environment is created.

The logic flow 700 may generate a second script 640 based on the collected configuration information 620 at block 706. This second script 640 may be generated by the first script 540.

The logic flow 700 may execute the second script 640 in the guest OS 150 running on the destination VM 145, the second script 640 reconfiguring the guest OS 150 to run on the destination VM 145 at block 708. The second script 640 may be executed by the first script 540 configuring the guest OS 150 while its running on the source VM 140 to automatically execute the second script 640 on a next booting up of the guest operating system. The first script 540 may then shut down the guest OS 150. The guest OS 150 may be booted up on the destination VM 145 after being shut down.

The first script 440 may configure the guest OS 150 to immediate boot after the shut down (e.g., a reboot), or may allow an external migration application 110 running without virtual machine mediation on the host OS 120 to boot the guest OS 150. This migration application 110 may act to have the next boot be on the destination VM 145 provided by the destination hypervisor 135 and may perform other tasks between the shut down of the guest OS 150 and its next boot to further the migration of the guest OS 150.

The second script 640 may reconfigure the guest OS 150 by creating associations between the guest OS 150 and one or more network interfaces of the destination VM 135 based on the NIC-to-MAC mapping.

The embodiments are not limited to this example.

FIG. 8 illustrates one embodiment of a logic flow 800 for the self-repairing configuration service of FIG. 1. The logic flow 800 may be representative of some or all of the operations executed by one or more embodiments described herein.

In the illustrated embodiment shown in FIG. 8, the logic flow 800 may start at block 702. The logic flow 700 may continuously execute a self-repairing configuration service for the guest OS 150 running on a VM 140 or 145, or more specifically, a host hypervisor 130 or 135. The self-repairing configuration service may be executed in the guest OS 150 and run as a service (e.g., in Window®) or a Daemon (in Unix/Linux). The VM 140 may be provided by a source hypervisor 130 or by a destination hypervisor 135, the source hypervisor 130 and destination hypervisor 135 differing in hardware virtualization as to prevent the guest OS 150 from making full use of the destination VM 135 without reconfiguration. In particular, the networking configuration of the guest OS 150 may be incompatible with the virtualized networking hardware presented to the guest OS 150 as part of the virtualized hardware environment of the destination VM 145. To overcome this challenge, the logic flow 800 may collect a universally unique identifier (UUID) upon shutdown of the guest OS 150 running on the VM 140 or 145 at block 704. The logic flow 800 may additionally, at step 804, collect configuration information 620 relating to the one or more network interfaces and one or more virtual machine disks upon shutdown of the guest operating system 150 on the virtual machine 140 or 145. The configuration information may comprise configuration information relating to one or more network interfaces and one or more virtual machine disks upon shutdown of the guest operating system on the virtual machine. The configuration information may comprise a NIC-to-MAC mapping between one or more network interfaces of the VM 140 or 145 and media access control addresses assigned to the one or more network interfaces of the VM 140 or 145. This mapping may allow the logic flow 800 to recreate the associations between non-virtualized, physical NICs and the virtualized NICs of the virtualized hardware environment despite changes in how the virtualized hardware environment is created.

The logic flow 800 may reconfigure one or more network interfaces and one or more virtual machine disks of the VM 140 or 145 for the guest OS 150 if a change to a host hypervisor 130 or 135, providing the VM 140 or 145, is detected upon startup of the guest OS 150 on the VM 140 or 145 at block 706.

The guest OS 150 may be booted up on the destination VM 140 or 145 after being shut down. The self repairing configuration service may configure the guest OS 150 to immediate boot after the shut down (e.g., a reboot), or may allow an external migration application 110 running without virtual machine mediation on the host OS 120 to boot the guest OS 150. This migration application 110 may act to have the next boot be on the destination VM 140 or 145 provided by the host hypervisor 130 or 135 and may perform other tasks between the shut down of the guest OS 150 and its next boot to further the migration of the guest OS 150.

The embodiments are not limited to this example.

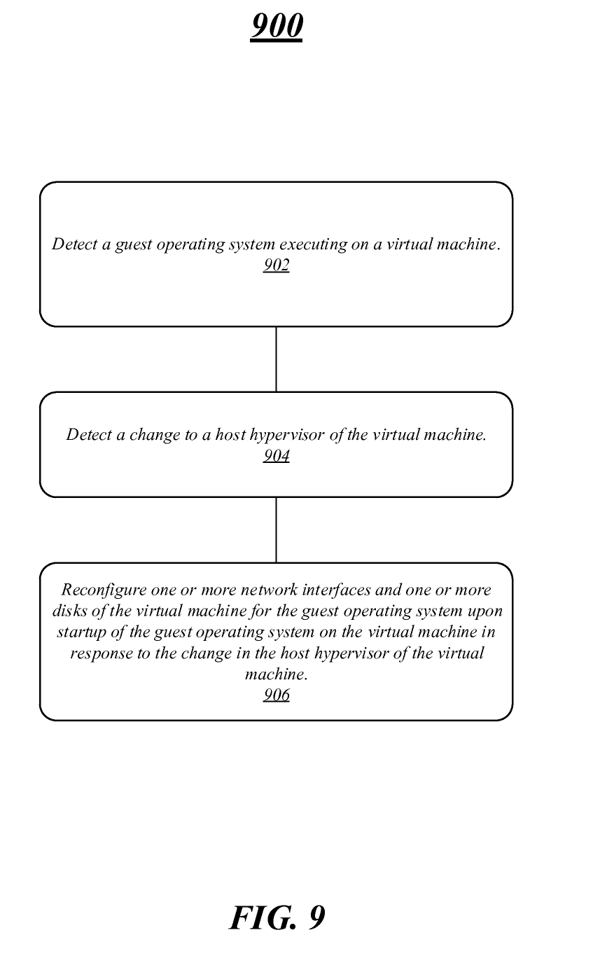

FIG. 9 illustrates an additional embodiment of a logic flow 900 for the self-repairing configuration service of FIG. 1. The logic flow 900 may be representative of some or all of the operations executed by one or more embodiments described herein.

In the illustrated embodiment shown in FIG. 9, the logic flow 900 may start at block 702. The logic flow 900 may detect a guest operating system 150 executing on a virtual machine 140 or 145, or more specifically, a host hypervisor 130 or 135. The self-repairing configuration service may be executed in the guest OS 150 and run as a service (e.g., in Window®) or a Daemon (in Unix/Linux). The VM 140 may be provided by a source hypervisor 130 or by a destination hypervisor 135, the source hypervisor 130 and destination hypervisor 135 differing in hardware virtualization as to prevent the guest OS 150 from making full use of the destination VM 135 without reconfiguration. The logic flow 900 may detect a change to a host hypervisor host hypervisor 130 or 135 of the virtual machine 140 or 145 at block 904. Upon detection of a change to a host hypervisor platform, the logic flow 900 may reconfigure one or more network interfaces and one or more virtual machine disks of the VM 140 or 145 for the guest OS 150 upon startup of the guest operating system 150 on the virtual machine 140 or 145 in response to the change in the host hypervisor 130 or 135 of the virtual machine 140 or 145 at block 906. The guest OS 150 may be booted up on the destination VM after being shut down. The self repairing configuration service may configure the guest OS to immediate boot after the shut down (e.g., a reboot), and the self repairing configuration service replaces the use of an external migration application 110 running without virtual machine mediation on the host OS 120 to boot the guest OS 150. This the self repairing configuration service may act to have the next boot be on the new hypervisor of a new virtual machine, and may perform other tasks between the shut down of the guest OS 150 and its next boot to further the migration of the guest OS 150.

The embodiments are not limited to this example.

FIG. 10 illustrates an additional embodiment of a logic flow 1000 for the self-repairing configuration service at the time of shutdown of the guest operating software of FIG. 1, or in other words, the logic flow 1000 for the self-repairing configuration service for the VM prep stage of the overall logic flow of FIG. 2. It should be noted that the self-repairing configuration service may replace all or only a portion of steps of FIG. 3 for the be the detailed logic flow for the VM prep stage of the overall logic flow 200 of FIG. 2. In the illustrated embodiment shown in FIG. 10, the logic flow 1000 may begin at block 1002. This may correspond to the transition of the overall logic flow 200 into block 240 of FIG. 2. The logic flow 1000 may be representative of some or all of the operations executed by one or more embodiments described herein. The logic flow 1000 shuts down (ends) a guest operating system 150 executing on a virtual machine 140 or 145, or more specifically, a host hypervisor 130 or 135 at block 1002. The self-repairing configuration service may be executed in the guest OS 150 and run as a service (e.g., in Window®) or a Daemon (in Unix/Linux). The VM 140 may be provided by a source hypervisor 130 or by a destination hypervisor 135, the source hypervisor 130 and destination hypervisor 135 differing in hardware virtualization as to prevent the guest OS 150 from making full use of the destination VM 135 without reconfiguration. At the time of the guest OS 150 shutdown, a guest OS shutdown notification may be received by the self-repairing configuration service “agent” from the guest operating system.

The logic flow 1000 obtains identifier information, which in one embodiment is a basic input/output system (BIOS) universally unique identification (UUID), to a host hypervisor host hypervisor 130 or 135 of the virtual machine 140 or 145 at block 1004. Moreover, at every shutdown of the guest OS 150, the self-repairing configuration service collects all network and disk (e.g., VM disk) information for the VM machine, as well as, an identifier of the VM environment, such as the basic input/output system (BIOS) universally unique identification (UUID) at blocks 1008 and 1012. Storing the BIOS UUID at the time of the guest OS shutdown allows the self-repairing configuration service “agent” to know what the BIOS UUID is at the exact time of shutdown. Thus, each time the guest OS shuts down, all the information needed to self-configure/repair in the destination format is captured at blocks 1004, 1008, and 1012. The logic flow 1000 stores the BIOS UUID at block 1006, and stores all the network and VM disk information at 1010 and blocks 1014 respectively. The logic flow then ends at 1016.

FIG. 11 illustrates an additional embodiment of a logic flow 1100 for the self-repairing configuration service of FIG. 1, or in other words, the logic flow 1100 for the self-repairing configuration service for the migration stage of the overall logic flow of FIG. 2. It should be noted that the self-repairing configuration service may replace all or only a portion of the steps of FIG. 4 for the detailed logic flow for the migration stage of the overall logic flow 200 of FIG. 2. In the illustrated embodiment shown in FIG. 11, the logic flow 1100 may begin at block 1102. This may correspond to the transition of the overall logic flow 200 into block 250 of FIG. 2.

The logic flow 1100 may be representative of some or all of the operations executed by one or more embodiments described herein. The logic flow 1100 may startup (boot up) a guest operating system 150 executing on a virtual machine 140 or 145, or more specifically, a host hypervisor 130 or 135 at block 1102. The self-repairing configuration service may be executed in the guest OS 150 (and/or in association with the guest OS 150) and run as a service (e.g., in Window®) or a Daemon (in Unix/Linux). The VM 140 may be provided by a source hypervisor 130 or by a destination hypervisor 135, the source hypervisor 130 and destination hypervisor 135 differing in hardware virtualization as to prevent the guest OS 150 from making full use of the destination VM 135 without reconfiguration.

The logic flow 1100 obtains identifier information, which in one embodiment is a basic input/output system (BIOS) universally unique identification (UUID), to a host hypervisor host hypervisor 130 or 135 of the virtual machine 140 or 145 at block 1104. At the time of the startup or reboot of the guest OS, the self-repairing configuration service “agent” seeks and obtains the current BIOS UUID of the guest operating system. Having previously stored the BIOS UUID at the time of the guest OS shutdown, the self-repairing configuration service “agent” compares the current identifier (e.g., the obtained BIOS UUID obtained at startup of the guest OS) with the stored identifier (e.g., the stored BIOS UUID obtained at shutdown of the guest OS) in order to detect any change to the host hypervisor. The logic flow 1100 determines if the host platform 130 or 135 has changed at the time of startup of the guest OS 150 at block 1106. For instance, the logic flow 1100 determines and checks if the BIOS UUID of the host virtual machine (VM) has changed at the time of start up of the guest OS 150. The logic flow 1100 may determine whether to install integration tools and services at block 1108. This determination may be an inherent consequence of whether the guest OS 150 was configured to automatically install integration tools and services for the new host hypervisor 130 or 135 at startup. If integration tools require installation, the logic flow 1100 proceeds to block 1110 to install the integration tools. Otherwise, the logic flow 1100 proceeds to block 1112. Upon detection of a change to a host hypervisor platform, the logic flow 1100 executes a network rehydration of a previous configuration or an alternative configuration at block 1112. For instance, one or more network interfaces of the VM for the guest OS 150 is reconfigured upon startup of the guest operating system 150 on the virtual machine 140 or 145 in response to the change in BIOS UUID of the virtual machine 140 or 145. Also following the detection of the change to a host hypervisor platform, the logic flow 1100 executes a disk rehydration (e.g., a reconfiguration) of a previous configuration or an alternative configuration at block 1114. For instance, one or more virtual machine disks of the VM for the guest OS 150 is reconfigured upon startup of the guest operating system 150 on the virtual machine 140 or 145 in response to the change in BIOS UUID of the virtual machine 140 or 145. The guest OS 150 may be booted up on the destination VM after being shut down. The self repairing configuration service may configure the guest OS to immediate boot after the shut down (e.g., a reboot), and the self repairing configuration service replaces the use of an external migration application 110 running without virtual machine mediation on the host OS 120 to boot the guest OS 150. This the self repairing configuration service may act to have the next boot be on the new hypervisor of a new virtual machine, and may perform other tasks between the shut down of the guest OS 150 and its next boot to further the migration of the guest OS 150. The logic flow then ends at 1116.

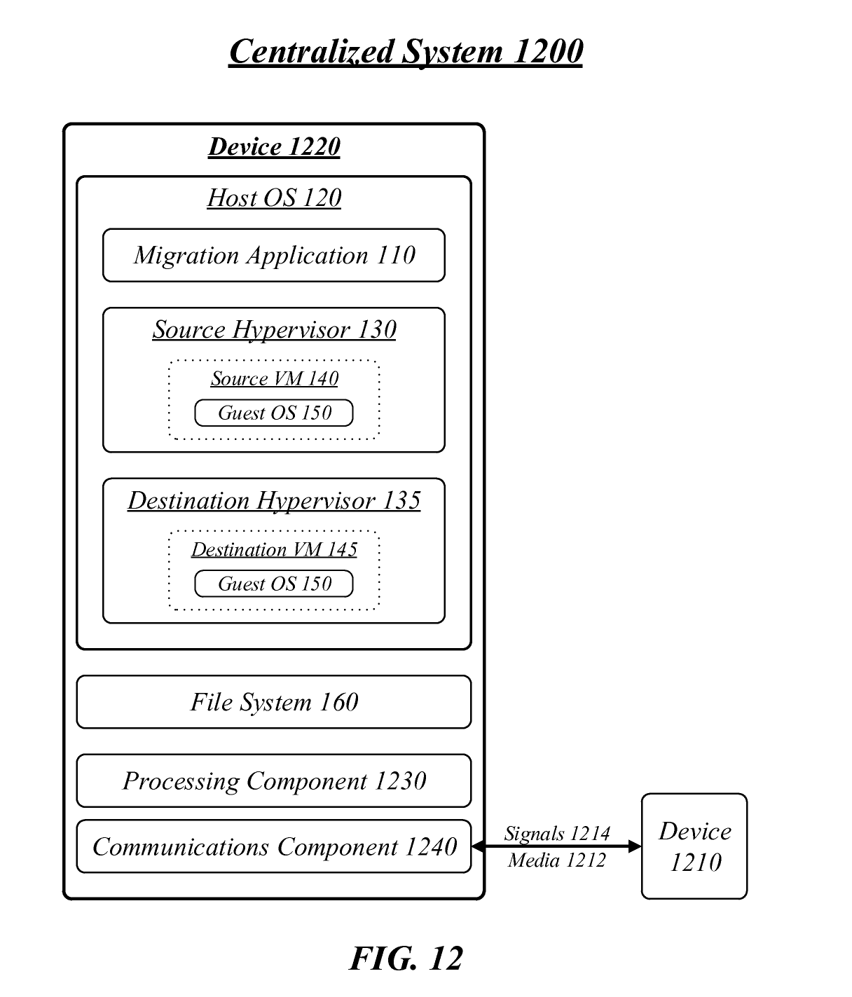

FIG. 12 illustrates a block diagram of a centralized system 1200. The centralized system 1200 may implement some or all of the structure and/or operations for the virtual machine migration system 100 in a single computing entity, such as entirely within a single device 1220.

The device 1220 may comprise any electronic device capable of receiving, processing, and sending information for the system 100. Examples of an electronic device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 1220 may execute processing operations or logic for the system 100 using a processing component 1230. The processing component 1230 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 1220 may execute communications operations or logic for the system 100 using communications component 1240. The communications component 1240 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 1240 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 1212 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 1220 may communicate with a device 1210 over a communications media 1212 using communications signals 1214 via the communications component 1240. The device 1210 may be internal or external to the device 1220 as desired for a given implementation.

The device 1220 may host the host OS 120, the host 120 running the migration application 110, source hypervisor 130, and destination hypervisor 135, with the source VM 140 and destination VM 145 provided by the respective hypervisors 130, 135. The device 1220 may also host the file system 160 storing the virtual disk blocks 190 for the source VM virtual disk 170 and destination VM virtual disk 175. The migration application 110 may perform the migration of the guest OS 150 from the source VM 140 to the destination VM 145 on the device 1220.

The device 1210 may provide support or control for the migration operations of the migration application 110 and/or the hosting operations of the device 1220 and host 120. The device 1210 may comprise an external device externally controlling the device 1220, such as where device 1210 is a server device hosting the guest OS 150 and the device 1210 is a client administrator device used to administrate device 1210 and initiate the migration using migration application 110. In some of these cases, the migration application 110 may instead be hosted on the device 1210 with the remainder of the virtual machine migration system 100 hosted on the device 1220. Alternatively, the device 1210 may have hosted the migration application 110 as a distribution repository, with the migration application 110 downloaded to the device 1220 from the device 1210.

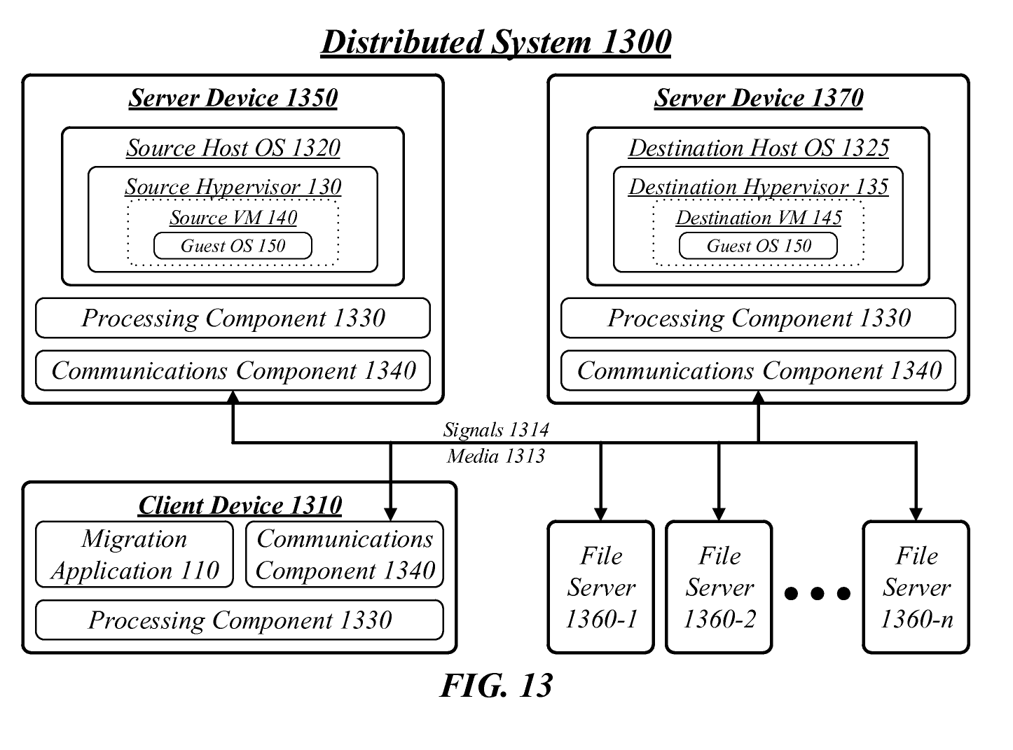

FIG. 13 illustrates a block diagram of a distributed system 1300. The distributed system 1300 may distribute portions of the structure and/or operations for the virtual machine migration system 100 across multiple computing entities. Examples of distributed system 1300 may include without limitation a client-server architecture, a S-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 1300 may comprise a client device 1310 and server devices 1350 and 1370. In general, the client device 1310 and the server devices 1350 and 1370 may be the same or similar to the client device 1220 as described with reference to FIG. 12. For instance, the client device 1310 and the server devices 1350 and 1370 may each comprise a processing component 1330 and a communications component 1340 which are the same or similar to the processing component 1130 and the communications component 1140, respectively, as described with reference to FIG. 11. In another example, the devices 1310, 1350, and 1370 may communicate over a communications media 1312 using communications signals 1314 via the communications components 1340. The distributed system 1300 may comprise a distributed file system implemented by distributed file servers 1360 including file servers 1360-1 through 1360-n, where the value of n may vary in different embodiments and implementations. The local storage of the client device 1310 and server devices 1350, 1370 may work in conjunction with the file servers 1360 in the operation of the distributed file system, such as by providing a local cache for the distributed file system primarily hosted on the file servers 1360 so as to reduce latency and network bandwidth usage for the client device 1310 and server devices 1350, 1370.

The client device 1310 may comprise or employ one or more client programs that operate to perform various methodologies in accordance with the described embodiments. In one embodiment, for example, the client device 1310 may implement the migration application 110 initiating, managing, and monitoring the migration of the guest OS 150 from the source VM 140 to the destination VM 145. The client device 1310 may use signals 1314 to interact with the source hypervisor 130, destination hypervisor 135 and/or guest OS 150 while they are running on each of the source VM 140 and destination VM 145, and file servers 1360.

The server devices 1350, 1370 may comprise or employ one or more server programs that operate to perform various methodologies in accordance with the described embodiments. In one embodiment, for example, the server device 1350 may implement a source host OS 1320 hosting the source hypervisor 130 providing the source VM 140. The server device 1350 may use signals 1314 to receive control signals from the migration application 110 on client device 1310 and to transmit configuration and status information to the migration application 110. The server device 1350 may use signals 1314 communicate with the file servers 1360 both for the providing of source VM 140 and for the migration of guest OS 150 from the source VM 140 to the destination VM 145.

The server device 1370 may implement a destination host OS 1325 hosting the destination hypervisor 135 providing the destination VM 145. The server device 1370 may use signals 1314 to receive control signals from the migration application 110 on client device 1310 and to transmit configuration and status information to the migration application 110. The server device 1370 may use signals 1314 communicate with the file servers 1360 both for the providing of destination VM 145 and for the migration of guest OS 150 to the destination VM 145 to the source VM 140.

In some embodiments, the same server device may implement both the source hypervisor 130 and the destination hypervisor 135. In these embodiments, the migration application 110 hosted on a client device 1310 may perform the migration of the guest OS 150 from the source VM 140 to the destination VM 145 on this single server device, in conjunction with migration operations performed using the distributed file system.

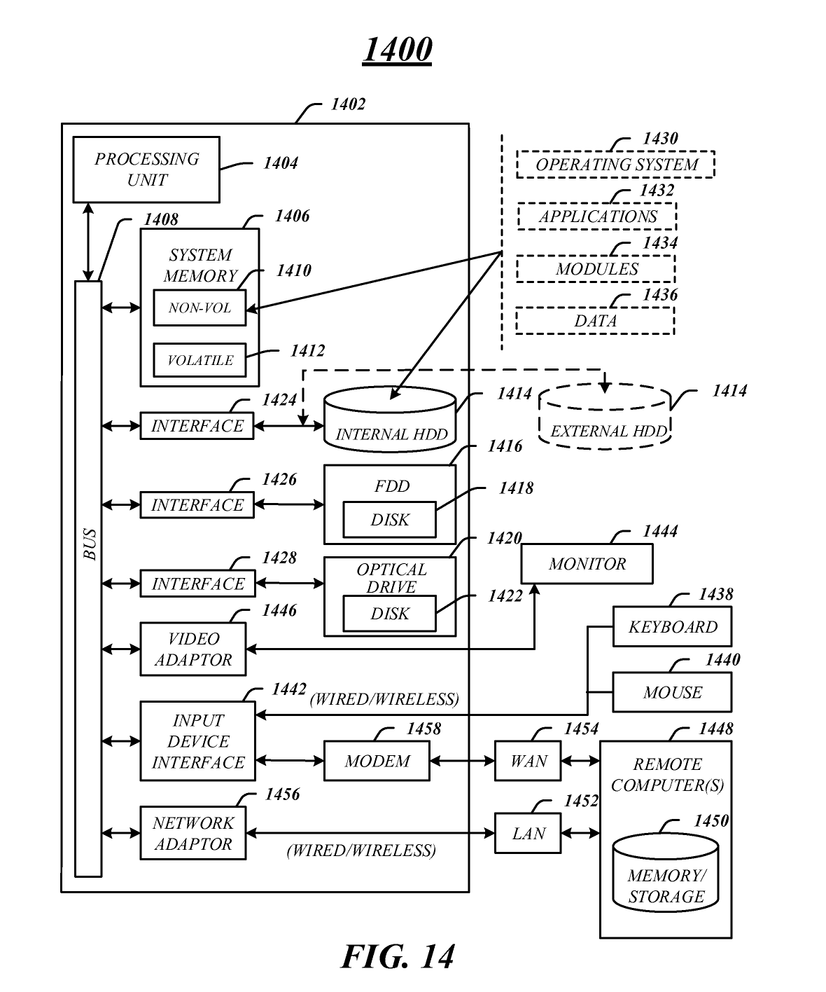

FIG. 14 illustrates an embodiment of an exemplary computing architecture 1300 suitable for implementing various embodiments as previously described. In one embodiment, the computing architecture 1300 may comprise or be implemented as part of an electronic device. Examples of an electronic device may include those described with reference to FIG. 12, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1400. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1400 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1400.

As shown in FIG. 14, the computing architecture 1400 comprises a processing unit 1404, a system memory 1406 and a system bus 1408. The processing unit 1404 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1404.

The system bus 1408 provides an interface for system components including, but not limited to, the system memory 1406 to the processing unit 1404. The system bus 1408 can be any of several types of bus structure that may further interconnect to a memory bus (with or without a memory controller), a peripheral bus, and a local bus using any of a variety of commercially available bus architectures. Interface adapters may connect to the system bus 1408 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1400 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1406 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 14, the system memory 1406 can include non-volatile memory 1410 and/or volatile memory 1412. A basic input/output system (BIOS) can be stored in the non-volatile memory 1410.

The computer 1402 may include various types of computer-readable storage media in the form of one or more lower speed memory units, including an internal (or external) hard disk drive (HDD) 1414, a magnetic floppy disk drive (FDD) 1416 to read from or write to a removable magnetic disk 1418, and an optical disk drive 1420 to read from or write to a removable optical disk 1422 (e.g., a CD-ROM or DVD). The HDD 1414, FDD 1416 and optical disk drive 1420 can be connected to the system bus 1408 by a HDD interface 1424, an FDD interface 1426 and an optical drive interface 1428, respectively. The HDD interface 1424 for external drive implementations can include at least one or both of Universal Serial Bus (USB) and IEEE 1494 interface technologies.

The drives and associated computer-readable media provide volatile and/or nonvolatile storage of data, data structures, computer-executable instructions, and so forth. For example, a number of program modules can be stored in the drives and memory units 1410, 1412, including an operating system 1430, one or more application programs 1432, other program modules 1434, and program data 1436. In one embodiment, the one or more application programs 1432, other program modules 1434, and program data 1436 can include, for example, the various applications and/or components of the system 100.

A user can enter commands and information into the computer 1402 through one or more wire/wireless input devices, for example, a keyboard 1438 and a pointing device, such as a mouse 1440. Other input devices may include microphones, infrared (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1404 through an input device interface 1442 that is coupled to the system bus 1408, but can be connected by other interfaces such as a parallel port, IEEE 1494 serial port, a game port, a USB port, an IR interface, and so forth.

A monitor 1444 or other type of display device is also connected to the system bus 1408 via an interface, such as a video adaptor 1446. The monitor 1444 may be internal or external to the computer 1402. In addition to the monitor 1444, a computer typically includes other peripheral output devices, such as speakers, printers, and so forth.

The computer 1402 may operate in a networked environment using logical connections via wire and/or wireless communications to one or more remote computers, such as a remote computer 1448. The remote computer 1448 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1450 is illustrated. The logical connections depicted include wire/wireless connectivity to a local area network (LAN) 1452 and/or larger networks, for example, a wide area network (WAN) 1454. Such LAN and WAN networking environments are commonplace in offices and companies, and facilitate enterprise-wide computer networks, such as intranets, all of which may connect to a global communications network, for example, the Internet.

When used in a LAN networking environment, the computer 1402 is connected to the LAN 1452 through a wire and/or wireless communication network interface or adaptor 1456. The adaptor 1456 can facilitate wire and/or wireless communications to the LAN 1452, which may also include a wireless access point disposed thereon for communicating with the wireless functionality of the adaptor 1456.

When used in a WAN networking environment, the computer 1402 can include a modem 1458, or is connected to a communications server on the WAN 1454, or has other means for establishing communications over the WAN 1454, such as by way of the Internet. The modem 1458, which can be internal or external and a wire and/or wireless device, connects to the system bus 1408 via the input device interface 1442. In a networked environment, program modules depicted relative to the computer 1402, or portions thereof, can be stored in the remote memory/storage device 1450. It will be appreciated that the network connections shown are exemplary and other means of establishing a communications link between the computers can be used.

The computer 1402 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

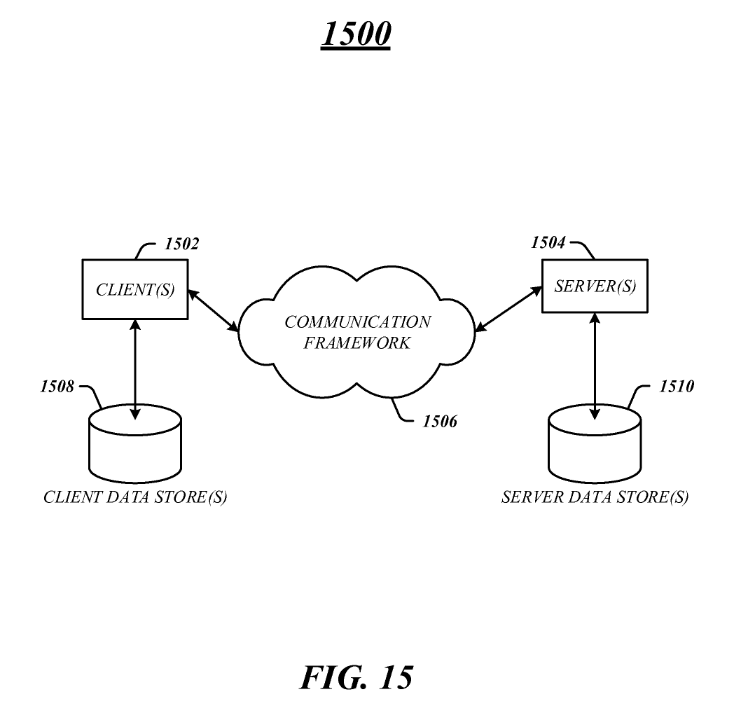

FIG. 15 illustrates a block diagram of an exemplary communications architecture 1500 suitable for implementing various embodiments as previously described. The communications architecture 1500 includes various common communications elements, such as a transmitter, receiver, transceiver, radio, network interface, baseband processor, antenna, amplifiers, filters, power supplies, and so forth. The embodiments, however, are not limited to implementation by the communications architecture 1500.

As shown in FIG. 15, the communications architecture 1500 comprises includes one or more clients 1502 and servers 1504. The clients 1502 may implement the client device 1310 shown in FIG. 13. The servers 1504 may implement the server device 1550 shown in FIG. 13. The clients 1502 and the servers 1504 are operatively connected to one or more respective client data stores 1508 and server data stores 1510 that can be employed to store information local to the respective clients 1502 and servers 1504, such as cookies and/or associated contextual information.

The clients 1502 and the servers 1504 may communicate information between each other using a communication framework 1506. The communications framework 1506 may implement any well-known communications techniques and protocols. The communications framework 1506 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1506 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1502 and the servers 1504. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
detecting a guest operating system executing on a virtual machine;
detecting a change to a host hypervisor of the virtual machine; and
reconfiguring one or more network interfaces and one or more disks of the virtual machine for the guest operating system upon startup of the guest operating system on the virtual machine in response to the change in the host hypervisor of the virtual machine.

2. The method of claim 1, wherein the detecting the change to the host hypervisor includes detecting a change to a UUID upon startup of the guest operating system on the virtual machine.

3. The method of claim 1, comprising:
collecting an identifier upon shutdown of the guest operating system on the virtual machine, and
collecting configuration information relating to the one or more network interfaces and the one or more disks upon shutdown of the guest operating system on the virtual machine.

4. The method of claim 1, comprising executing a self-repairing configuration service for the guest operating system for the reconfiguring and collecting an identifier of the virtual machine and configuration information relating to the one or more network interfaces and the one or more disks upon shutdown of the guest operating system on the virtual machine.

5. The method of claim 1, comprising:
storing an identifier in a configuration file upon the shutdown of the guest operating system on the virtual machine,
collecting a current identifier upon the startup of the guest operating system,
comparing the current identifier and the stored identifier in order to detect the change to the host hypervisor, and
reconfiguring the one or more network interfaces and the one or more disks of the virtual machine for the guest operating system in response to the change in the host hypervisor of the virtual machine from a previous configuration or an alternative configuration.

6. The method of claim 1, comprising:
registering a self-repairing configuration service to receive commands of the guest operating system,
sending a notification to the guest operating system by the self-repairing configuration service that the UUID and configuration information relating to the one or more network interfaces and the one or more disks has been collected, and
receiving a guest operating system shutdown notification by the self-repairing configuration service from the guest operating system.

7. The method of claim 1, comprising detecting a migration of the guest operating system executing on a source virtual machine to executing on a destination virtual machine, the source virtual machine provided by a source hypervisor, the destination virtual machine provided by a destination hypervisor.

8. An apparatus, comprising:
a processor circuit on a device;
a self-repairing configuration service component operative on the processor circuit to execute a self-repairing configuration service for a guest operating system executing on a virtual machine, the self-repairing configuration service to detect a guest operating system executing on the virtual machine, detect a change to a host hypervisor of the virtual machine, and reconfigure one or more network interfaces and one or more disks of the virtual machine for the guest operating system upon startup of the guest operating system on the virtual machine in response to the change in the host hypervisor of the virtual machine.

9. The apparatus of claim 8, wherein the change to the host hypervisor comprises a change to a universally unique identifier (UUID) upon startup of the guest operating system on the virtual machine.

10. The apparatus of claim 8, the self-repairing configuration service component operative to collect an identifier upon shutdown of the guest operating system on the virtual machine and collect configuration information relating to the one or more network interfaces and the one or more disks upon shutdown of the guest operating system on the virtual machine.

11. The apparatus of claim 8, the self-repairing configuration service component operative to execute a self-repairing configuration service for the guest operating system to reconfigure the one or more network interfaces and the one or more disks of the virtual machine for the guest operating system upon startup of the guest operating system on the virtual machine in response to the change in the host hypervisor of the virtual machine and to collect an identifier of the virtual machine and configuration information relating to the one or more network interfaces and the one or more disks upon shutdown of the guest operating system on the virtual machine.

12. The apparatus of claim 8, the self-repairing configuration service component operative to store an identifier in a configuration file upon the shutdown of the guest operating system on the virtual machine, collect a current identifier upon the startup of the guest operating system, compare the current identifier and the stored identifier in order to detect the change to the host hypervisor, and reconfigure the one or more network interfaces and the one or more disks of the virtual machine for the guest operating system in response to the change in the host hypervisor of the virtual machine from a previous configuration or an alternative configuration.

13. The apparatus of claim 8, further comprising the self-repairing configuration service component operative to register the self-repairing configuration service for receiving commands of the guest operating system, send a notification to the guest operating system by the self-repairing configuration service that the UUID and configuration information relating to the one or more network interfaces and the one or more disks has been collected, or receive a guest operating system shutdown notification by the self-repairing configuration service from the guest operating system machine.

14. The apparatus of claim 8, further comprising the self-repairing configuration service component operative to detect a migration of the guest operating system running on a source virtual machine to running on a destination virtual machine, the source virtual machine provided by a source hypervisor, the destination virtual machine provided by a destination hypervisor.

15. At least one non-transitory computer-readable storage medium comprising instructions that, when executed, cause a system to:
detect a guest operating system executing on a virtual machine;
detect a change to a host hypervisor of the virtual machine; and
reconfigure one or more network interfaces and one or more disks of the virtual machine for the guest operating system upon startup of the guest operating system on the virtual machine in response to the change in the host hypervisor of the virtual machine.

16. The computer-readable storage medium of claim 15, wherein the change to the host hypervisor comprises a change to a universally unique identifier (UUID) upon startup of the guest operating system on the virtual machine.

17. The computer-readable storage medium of claim 15, comprising further instructions that, when executed, cause a system to collect an identifier upon shutdown of the guest operating system on the virtual machine and collect configuration information relating to the one or more network interfaces and the one or more disks upon shutdown of the guest operating system on the virtual machine.

18. The computer-readable storage medium of claim 15, comprising further instructions that, when executed, cause a system to execute a self-repairing configuration service for the guest operating system to reconfigure the one or more network interfaces and the one or more disks of the virtual machine for the guest operating system upon startup of the guest operating system on the virtual machine in response to the change in the host hypervisor of the virtual machine, and to collect an identifier of the virtual machine and configuration information relating to the one or more network interfaces and the one or more disks upon shutdown of the guest operating system on the virtual machine.

19. The computer-readable storage medium of claim 15, comprising further instructions that, when executed, cause a system to store an identifier in a configuration file upon the shutdown of the guest operating system on the virtual machine, collect a current identifier upon the startup of the guest operating system, compare the current identifier and the stored identifier in order to detect the change to the host hypervisor, reconfigure the one or more network interfaces and the one or more disks of the virtual machine for the guest operating system in response to the change in the host hypervisor of the virtual machine from a previous configuration or an alternative configuration, register the self-repairing configuration service for receiving commands of the guest operating system, send a notification to the guest operating system by the self-repairing configuration service that the UUID and configuration information relating to the one or more network interfaces and the one or more disks has been collected, or receive a guest operating system shutdown notification by the self-repairing configuration service from the guest operating system machine

20. The computer-readable storage medium of claim 15, comprising further instructions that, when executed, cause a system to detect a migration of the guest operating system running on a source virtual machine to running on a destination virtual machine, the source virtual machine provided by a source hypervisor, the destination virtual machine provided by a destination hypervisor.
